(19) United States
(12) Patent Application Publication
(10) Pub. No.: US 2021/0344058 A1
(43) Pub. Date: Nov. 4, 2021

(54) PROCESS FOR RECOVERING LITHIUM AND TRANSITION METALS FROM WASTE CATHODE OF SPENT LITHIUM ION BATTERY

(71) Applicant: XProEM Ltd., Oakville (CA)

(72) Inventors: Xintong LIU, Oakville (CA); Chattopadhyay KINNOR, Toronto (CA)

(21) Appl. No.: 17/230,937

(22) Filed: Apr. 14, 2021

Related U.S. Application Data
(60) Provisional application No. 63/019,204, filed on May 1, 2020.
(60) Provisional application No. 63/078,860, filed on Sep. 15, 2020.

(51) Int. Cl. H01M 10/54; H01M 10/0525; C22B 15/00; C22B 26/12

(52) U.S. Cl. CPC H01M 10/54; H01M 10/0525; C22B 26/12; C22B 15/0056; C22B 15/0052

(57) ABSTRACT

The present invention is a process for directly recovering lithium and valuable transition metals such as cobalt, nickel and manganese from waste cathode and anode powder of spent lithium ion batteries into high grade products through a cascade reduction reaction scheme, followed by digestion and precipitation circuit using CO₂ as media, and a series of physical separation procedures.

### FIELD

The present application relates a method for directly recovering lithium and transition metals in their respective compound or metallic forms from spent lithium ion batteries using a solid-state reduction process, followed by a series of separation procedures. Specifically, the present disclosure pertains to a method for recovering lithium and transition metals from spent lithium ion batteries.

### BACKGROUND

Use of lithium ion batteries (LIBs) has proliferated recently due to their high energy density and power output per unit of battery weight, allowing them to be lighter and smaller than other rechargeable batteries for a variety of applications, including widespread use in portable electronic devices, for energy storage and to power electric vehicles (EVs). Over the last 5 years in particular, there has been a strong increase in the global production and use of EVs. An estimated 2 million EVs (including hybrid plug-in types) were manufactured and sold in 2018, with rapid growth expected to continue to the point where the total fleet of EVs in circulation is expected to exceed 50 million by 2025 and reach 125 million by 2030 globally. As battery capacity and energy levels increase to match the demand for longer travelling distance per charge, improvements to LIB technology are expected to continue.

LIBs operate based on a layered active electrode material that enables Li-ion insertion and transfer between positive (cathode) and negative (anode) electrodes during discharge and charge. The working mechanism and performance of LIBs are tightly linked to the properties of the cathode material, which commercially consists of an electrochemically active compound of lithium nickel cobalt manganese oxide in the case of NCM LIB; or consists of an electrochemically active compound of lithium cobalt oxide in the case of LCO LIB, or lithium nickel oxide in the case of LNO LIB. In addition to this active lithium containing material, the cathode is also composed of aluminum plate, electric conductor, PVDF binder and additives. The other main components of the LIB are graphite (anode), Al and Cu foil, polymeric separator, as well as a lithium-bearing electrolyte.

An issue the LIB industry faces in particular is what to do with spent batteries once vehicles are retired, or the batteries are past their useful life, usually within a span of 4-5 years in use. It is therefore highly desirable to recycle spent LIB packs and recover the high value materials contained therein either for reuse in manufacturing of new LIB packs or other related industrial applications. Given the multitude of different materials used for different components of the battery pack, their liberation from the enclosed LIB pack and subsequent separation from each other requires a separation scheme capable of disintegrating the battery pack as well as partition each of the desired components in an efficient fashion. As a first step, shredding is commonly applied to discharged and dismantled LIB packs to reduce the overall size of enclosed components.

A number of physical separation processes have been developed, with specialized equipment to effectively separate components based on gravity, volatility and particle size, capable of removing the lithium-bearing electrolyte, anode material, copper foil and aluminum casing. Such pre-treatment procedures can also remove majority of volatile and plastic binder materials by application of high temperature roasting.

Whilst effective at physically separating the different LIB pack components, there remains a strong need for the development of an economically viable, environmentally sustainable and operationally efficient metallurgical technology to process the residual powder of separated LIB cathode active material, commonly known as the “Black Mass”. In the case of NCM LIBs, the Black Mass contains high purity LiNiCoMnO₂, as well as trace amounts of carbon, aluminum and copper. In the case of LCO and LNO LIBs, the Black Mass contains high purity LiCoO₂ and LiNiO₂, respectively, as well as trace amounts of carbon, aluminum and copper.

The present disclosure develops a process to recover value from the Black Mass of NCM LIBs, LCO LIB, and LNO LIB, under the assumption that previous physical separation steps have successfully removed majority of the electrolyte, other metallic components, and graphite from the anode. Compared to alternative current state-of-the-art technologies, the present disclosure is a fundamentally pyro-metallurgical process which does not involve the use of any toxic chemical solvent to leach transition metals species, and does not require complex and expensive solvent regeneration or additional procedures to treat toxic wastewater for environmental purposes.

Currently developed state-of-the-art hydrometallurgical processes for recycling such cathode material involves the use of chemical solvents (such as acidic/basic solutions or organic solvents), resulting in a conceptually complicated, operationally laborious and economically unfavorable flowsheet. The present disclosure shows clear advantages in terms of capital requirements, operational efficiency and environmental sustainability over traditional hydrometallurgical process routes. In addition, unlike other high temperature pyro-metallurgical processes, the present disclosure avoids melting of metal oxides or metallics, which can be otherwise prohibitively energy intensive and potentially hazardous.

### SUMMARY

According one aspect of the present disclosure, it relates to a method of recovering high value lithium and transition metals from spent NCM LIBs, as described herein. Assuming that the cathode material has been sufficiently separated from the rest of battery pack (i.e. electrolyte, other metallic components, graphite) at a reasonably high purity (>85% w/w), the lithium and nickel/cobalt recovery achieved by the process may be >90% or even >95%.

The process for recovering lithium and cobalt from pretreated Black Mass comprises the steps of:
a) adding carbon and other feed material to Black Mass and mixing them well
b) heating the Black Mass mixture in a controlled atmosphere to target temperature
c) adding CO/CO₂ gas mixture to react with heated Black Mass while holding the temperature constant for sufficient residence time
d) cooling down the products from reaction to room temperature in a controlled atmosphere
e) washing the partially reduced Black Mass and gravity separating lighter residual carbon
f) dissolving insoluble non-magnetic material after e) under CO₂-rich conditions to form soluble lithium bicarbonate and cobalt carbonate hydroxide complex into the leachate solution
g) filtering the insoluble material from the slurry discharged from f)
h) heating the filtered mass in a controlled atmosphere to target temperature
i) adding CO/CO₂ gas mixture to react with heated filtered mass while holding the temperature constant for sufficient residence time
j) wet magnetically separating reduced metallic nickel from the material collected from previous step i) for drying and collection
k) drying of residual non-magnetic manganese oxide recovered from previous step j)
l) precipitating cobalt carbonate hydrate and lithium carbonate from the leachate solution produced from step f)
m) filtering and drying of the precipitated mass containing cobalt and lithium
n) heating the dried mass to form cobalt (II) oxide from lithium carbonate hydrate in an inert atmosphere
o) if metallic cobalt is the preferred cobalt-containing product,
   a. continue to heat the filtered mass from step n) in a controlled atmosphere to target temperature
   b. adding CO/CO₂ gas mixture to react with heated filtered mass while holding the temperature constant for sufficient residence time
   c. wet magnetically separating reduced metallic cobalt from non-magnetic substances for drying and collection
   d. recovering lithium carbonate from the non-magnetic material after drying
p) if cobalt oxide is the preferred cobalt containing product,
   a. cooling of the mixture from step n) containing cobalt oxide and lithium carbonate in an inert atmosphere
   b. washing lithium carbonate off from insoluble cobalt oxide using cold water
   c. drying of cobalt oxide for collection
   d. recovering lithium carbonate from cold washing water via evaporative crystallization

The Black Mass is well mixed with added carbon to form the feed material. Heating is first applied to the mixed Black Mass in an inert atmosphere to heat up the feed mixture material to 400-600 degrees Celsius, to ensure removal of any volatile substances and prepare the Black Mass for subsequent partial reduction of nickel and cobalt. At above 400 degrees Celsius, carbon monoxide and solid carbon added start to react with the Black Mass and remove oxygen from the oxide crystal lattice. Both nickel and cobalt can be reduced from their original covalent states due to their lower activation energy and higher reactivity to reductants such as carbon monoxide and carbon. On the other hand, manganese will not respond to the subjected redox reaction due to the higher stability of its oxides. The temperature should not exceed 600 degrees Celsius to ensure majority of nickel and cobalt are reduced to their oxide forms in the lower covalent state, namely cobalt (II) oxide and nickel (II) oxide. Lithium carbonate will also form as a result of partial decomposition and reduction.

The solid-state reactants are then cooled in inert gas and washed by demineralized water to remove soluble impurities, and lighter materials such as carbon can be recovered through a flotation mechanism. The heavier stream largely comprises of lithium carbonate and transition metal oxides (including cobalt (II) oxide, nickel (II) oxide and manganese oxide) with trace amounts of carbon. Cooled water is added to dissolve lithium carbonate and cobalt oxide present in the mixture stream in a CO₂-enriched environment. CO₂ gas is added to this digestion step to increase the solubility of lithium carbonate and cobalt oxide by converting them into lithium bicarbonate and carbonate hydroxide complex respectively. Filtration or other conventional settling techniques may be applied to remove insoluble oxides and any metal particles formed from the partial reduction step.

The insoluble filtered solid mixture is sent to undergo a complete reduction step to reduce the contained nickel back to its metallic state. The reduction is achieved by reacting the mixture with dried carbon recovered from previous step and a gas mixture of CO/CO₂, in the temperature range of 650-800 degrees Celsius. Again, the mixture stream following the reduction step is cooled and washed to remove any remaining carbon. Anti-oxidizing agents are also added to the washing water to prevent re-oxidation of reduced nickel. Metallic nickel is magnetically active; therefore the slurry stream is subjected to a subsequent magnetic separation process. Manganese oxide and other non-magnetic oxides are then concentrated in the slurry stream, along with remaining impurities. Metallic nickel concentrated in the magnetic stream is dried and stored under proper conditions. The slurry can be de-watered and concentrated using a thickening and drying circuit to produce high purity manganese oxide.

The clear solution containing lithium bicarbonate and cobalt carbonate hydroxide is then subjected to an evaporative crystallization scheme to produce high purity cobalt carbonate hydrate and lithium carbonate crystals. Cobalt carbonate hydrate is converted to cobalt oxide via an oxygen-free roasting process. The cobalt oxide formed after the thermal treatment can either be converted to metallic form through a complete reduction step and recovered by magnetic separation, or recovered as is by washing off the lithium carbonate. In either case, the lithium carbonate will be captured in the tailing stream or the washing water, and recovered through drying or evaporation crystallization to form crystal lithium carbonate again.
1. A process for recovering lithium and transition metals, namely cobalt and nickel for spent NCM LIBs, from Black Mass powders physically separated from other parts and materials of used battery packs, comprising of:
   I. partial reduction of Black Mass with added carbon in a reducing atmosphere facilitated by gas mixture of CO and CO₂;
   II. separating residual carbon from other substances from partially reduced Black Mass using gravity separation;
   III. digestion of lithium carbonate and cobalt oxide in a cooled aqueous solution facilitated by CO₂ injection and carbonate-bicarbonate ionic system;
   IV. filtering nickel oxide and manganese oxide from leachate solution containing soluble lithium and cobalt species
   V. complete reduction of nickel oxide with added carbon in a reducing atmosphere facilitated by gas mixture of CO and CO₂
   VI. separating magnetic metallic nickel from non-magnetic tailing using wet magnetic separation;
   VII. precipitation of lithium carbonate and cobalt carbonate hydrate from the leachate solution via evaporative crystallization;
   VIII. calcination of precipitated crystal mixture to form cobalt oxide and lithium carbonate
2. A process according to claim 1 wherein the cobalt oxide and lithium carbonate mixture is reduced in a reducing atmosphere facilitated by gas mixture of CO and CO₂ to form metallic cobalt
3. A process according to claim 2 wherein the products from cobalt reduction are separated using magnetic separation into metallic cobalt and a slurry stream containing lithium carbonate.
4. A process according to claim 3 wherein the abovementioned slurry stream is dried to obtain lithium carbonate crystal.
5. A process according to claim 1 wherein the cobalt oxide and lithium carbonate mixture is washed using cold water to remove lithium carbonate from cobalt oxide.
6. A process according to claim 5 wherein the lithium carbonate precipitates from the abovementioned washing water using evaporative crystallization
7. A process according to claim 1 wherein the source of carbon comprises of lignite coal, anthracite charcoal, activated carbon or a type of carbon-bearing substance with limited amounts of volatile and low impurity level.
8. A process according to claim 1 wherein the CO/CO₂ volumetric ratio in gas stream added to partial reduction is from 1:2 to 2:1.
9. A process according to claim 1 wherein the CO/CO₂ volumetric ratio in gas stream added to complete reduction is from 1:1 to 4:1.
10. A process according to claim 1 wherein the temperature of partial reduction of Black Mass from spent NCM LIB is 400-600 degrees Celsius.
11. A process according to claim 1 wherein the temperature of complete reduction of nickel oxide from abovementioned partially reduced Black Mass is 650-800 degrees Celsius.
12. A process according to claim 1 wherein the temperature of decomposition of cobalt carbonate hydrate from abovementioned precipitated crystal mixture is 400-700 degrees Celsius.
13. A process according to claim 2 wherein the temperature of complete reduction of cobalt oxide is 600-750 degrees Celsius.
14. A process according to claim 1 wherein reaction time for partial reduction of Black Mass is 1-4 hours.
15. A process according to claim 1 wherein reaction time for complete reduction of nickel oxide is 2-8 hours.
16. A process according to claim 1 wherein reaction time for decomposition of cobalt carbonate hydrate is 1-4 hours.
17. A process according to claim 2 wherein reaction time for complete reduction of cobalt oxide is 2-8 hours.
18. A process according to one of claims 1 to 2 wherein inert gas such as Argon or Nitrogen is applied during heating or cooling
19. A process according to one of claim 1 or 3 wherein magnetic strengths in wet magnetic separation for a two-pass practice are 100-200 mT and 200-400 mT.
20. A process according to one of claim 1 or 3 wherein magnetic strength in wet magnetic separation for one-pass practice is 100-200 mT.
21. A process according to one of claim 1 or 5 wherein demineralized water added for lithium carbonate (and cobalt oxide as applicable) digestion is cooled to 0-5 degrees Celsius, and temperature of entire digestion process is maintained at 0-5 degrees Celsius.
22. A process according to claim 1 wherein digestion of lithium carbonate and cobalt oxide is carried out with CO₂ gas injection.
23. A process according to claim 1 wherein the time for digestion of lithium carbonate and cobalt oxide is 1-6 hours.
24. A process according to one of claim 1 or 6 wherein the temperature for evaporative crystallization of lithium carbonate is 60-80 degrees Celsius.
25. A process according to one of claim 1 or 6 wherein the holding time for evaporative crystallization of lithium carbonate is 4-12 hours.

According to another aspect of the present disclosure, it relates to a method of recovering high value lithium and transition metals, from spent LCO or LNO LIBs, as described herein. Assuming that the cathode material has been sufficiently separated from the rest of battery pack in reasonably high purity (>85% w/w), the lithium and cobalt recovery achieved by the process may be >90% or even >95%.

The process for recovering lithium and cobalt from pretreated Black Mass comprises the steps of:
a) adding carbon and other feed material to Black Mass and mixing them well
b) heating the Black Mass mixture in a controlled atmosphere to target temperature
c) adding CO/CO₂ gas mixture to react with heated Black Mass while holding the temperature constant for sufficient residence time
d) cooling down the products from reaction to room temperature in a controlled atmosphere
e) washing the reduced Black Mass and gravity separating lighter residual carbon
f) wet magnetically separating transition metals from non-magnetic substances
g) dissolving insoluble lithium carbonate under CO₂ rich conditions and removing insoluble impurities
h) precipitating lithium carbonate from lithium bicarbonate bearing solution
i) drying any residual cobalt or nickel bearing material recovered from previous steps
j) adding back dried transition metal species bearing material to step a)

Heating is first applied to the Black Mass in an inert atmosphere to heat up the feed mixture material to 650-750 degrees Celsius, to ensure removal of any volatile substances and prepare the Black Mass for subsequent reductive decomposition reaction. At above 650 degrees Celsius, the strong reducing power of carbon monoxide and solid carbon allows for reaction with oxygen in the oxide lattice, thus removing one oxygen atom and disintegrating the lattice structure of the oxides. The decomposed oxides are simultaneously converted to lithium carbonate salt and oxide of transition metal. The resultant cobalt oxides or nickel oxides are further reduced by carbon monoxide (and hydrogen if present) into metallic cobalt or nickel, in the presence of residual carbon.

The solid-state reactants are then cooled in inert gas and washed by demineralized water to remove soluble impurities, and lighter materials such as graphite may be removed through a flotation mechanism. Anti-oxidizing agents are also added to the washing water to prevent re-oxidation of reduced transition metals. Metallic cobalt or nickel is not water soluble but ferro-magnetically active, therefore its slurry stream is subject to a subsequent magnetic separation process using commercially available wet magnetic separators. Lithium carbonate and any non-magnetic oxide impurities are then concentrated in the non-magnetic stream, along with remaining carbon, copper and aluminum. Metallic cobalt or nickel is concentrated in the magnetic stream and dried and stored under proper conditions, ready for sale as is, or additional value-adding processing to enter the market for high premium products.

The non-magnetic stream largely comprises of lithium carbonate with trace amounts of graphite and other metal oxides. Cooled water is added to dissolve lithium carbonate present in the non-magnetic stream. Filtration or other conventional settling techniques may be applied to remove undesired insoluble impurities such as oxide and metal particles. CO₂ gas, including that generated from the offgas flaring, is routed to this digestion step to increase the solubility of lithium carbonate by converting it into lithium bicarbonate. The clear lithium bicarbonate bearing solution is then subject to evaporative crystallization to produce high purity lithium carbonate crystals, which is dried and packaged for sale as commercial grade lithium carbonate product. Further treatment and recycling of the insoluble slurry collected from the settling step may be justified on the basis of operational economics and cost effectiveness.
1. A process for recovering lithium and transition metals, namely cobalt and nickel for spent LCO and LNO LIBs, from Black Mass powders physically separated from other parts and materials of used battery packs, comprising of:
   IX. reductive decomposition of Black Mass with added carbon in a reducing atmosphere facilitated by gas mixture of CO and CO₂;
   X. separating residual carbon from other substances from reduced Black Mass using gravity separation;
   XI. separating ferro-magnetic metallic products from non-magnetic tailing using wet magnetic separation;
   XII. digestion of lithium carbonate in a cooled aqueous solution facilitated by CO₂ injection and lithium carbonate-bicarbonate system;
   XIII. precipitation of lithium carbonate from the lithium-bearing solutions via evaporative crystallization.
2. A process according to claim 1 wherein the Black Mass is from spent LCO LIB and comprising mostly lithium cobalt oxide in its composition.
3. A process according to claim 1 wherein the Black Mass is from spent LNO LIB and comprising mostly lithium nickel oxide in its composition.
4. A process according to one of claims 1 to 3 wherein the source of carbon comprises of lignite coal, anthracite charcoal, activated carbon or a type of carbon-bearing substance with limited amounts of volatile and low impurity level.
5. A process according to one of claims 1 to 3 wherein the CO/CO₂ volumetric ratio in gas stream added to reductive decomposition is from 1:2 to 4:1.
6. A process according to claim 2 wherein the temperature of reductive decomposition of Black Mass from spent LCO LIB is 650-750 degrees Celsius.
7. A process according to claim 3 wherein the temperature of reductive decomposition of Black Mass from spent LNO LIB is 700-800 degrees Celsius.
8. A process according to one of claims 1 to 3 wherein reaction time for reductive decomposition of Black Mass is 3-6 hours.
9. A process according to one of claims 1 to 3 wherein total carbon in Black Mass mixture, combined from graphite carried over from spent LIB packs, freshly added carbon and recycled carbon is around 10-30 wt %.
10. A process according to one of claims 1 to 3 wherein water is added at ambient temperature, or slightly above, to wash and recover residual carbon.
11. A process according to one of claims 1 to 3 wherein magnetic strengths in wet magnetic separation for a two-pass practice are 100-200 mT and 200-400 mT.
12. A process according to claim 11 wherein magnetic strength in wet magnetic separation for one-pass practice is 100-200 mT.
13. A process according to one of claim 11 or 12 wherein demineralized water added to the head or tailings for lithium carbonate digestion is cooled to 0-5 degrees Celsius, and temperature of entire digestion process is maintained at 0-5 degrees Celsius.
14. A process according to claim 13 wherein lithium carbonate digestion is carried out with CO₂ gas injection.
15. A process according to one of claim 14 wherein the time for digestion of lithium carbonate is 1.5-3 hours.
16. A process according to claim 15 wherein the temperature for evaporative crystallization of lithium carbonate is 60-80 degrees Celsius.
17. A process according to claim 16 wherein the holding time for evaporative crystallization of lithium carbonate is 8-10 hours.
18. A process according to claim 2 wherein carried over cobalt compounds in the lithium-bearing solution are gravity separated after precipitating out as impurities to lithium carbonate.

### BRIEF DESCRIPTION OF THE FIGURES

For a better understanding of the present application, as well as other aspects, embodiments, and further features thereof, reference is made to the following description which is to be used in conjunction with the accompanying figures and/or tables, where:

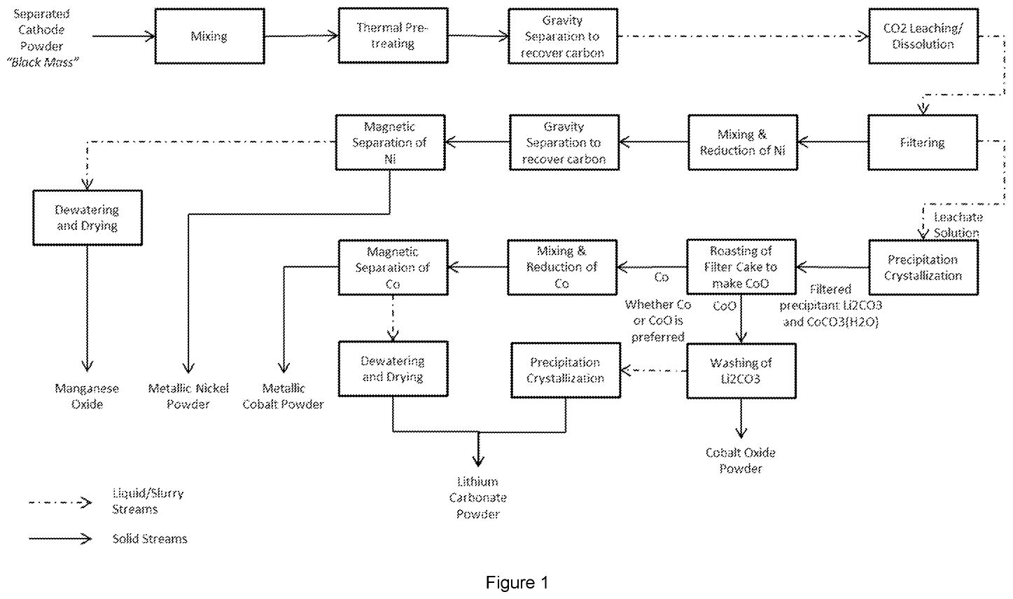

1) FIG. 1 shows a block flow diagram of an embodiment of the depicted process.

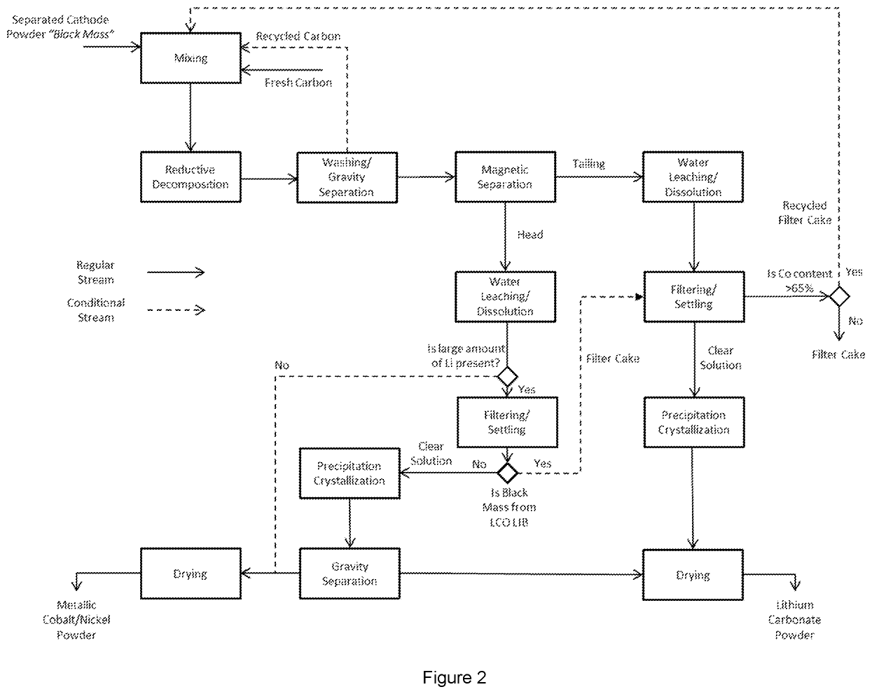

2) FIG. 2 shows a block flow diagram of another embodiment of the depicted process.

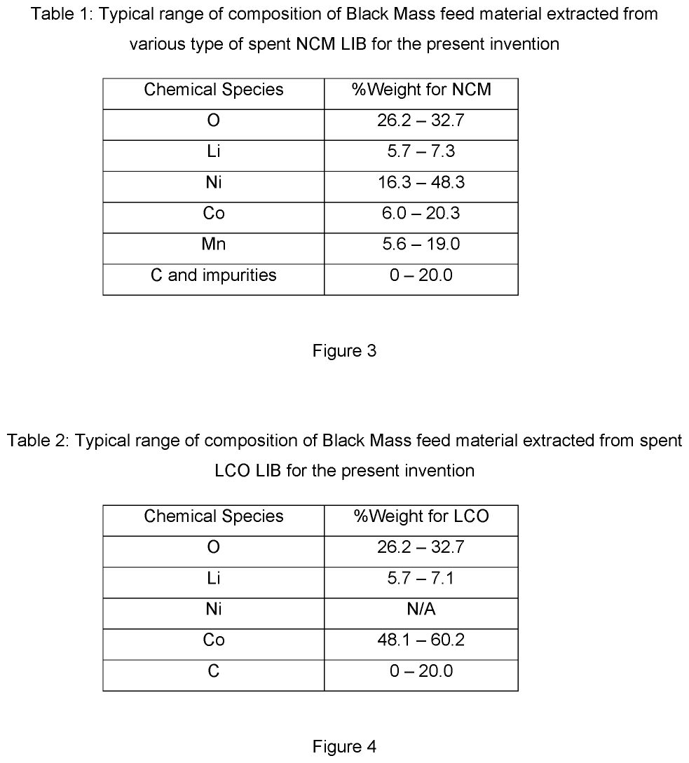

3) FIG. 3 shows Table 1, which summarizes the typical range of composition of the Blass Mass from NCM type of spent LIB which the present disclosure can process effectively.

4) FIG. 4 shows Table 2, which summarizes the typical range of composition of the Blass Mass from LCO type of spent LIB which the present disclosure can process effectively.

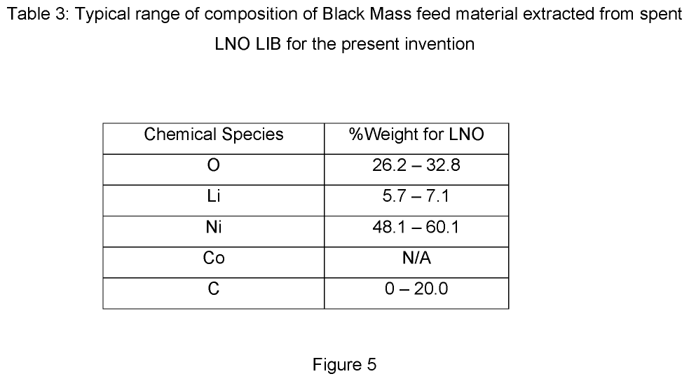

5) FIG. 5 shows Table 3, which summarizes the typical range of composition of the Blass Mass from LNO type of spent LIB which the present disclosure can process effectively.

### DETAILED DESCRIPTION

The present disclosure outlines a method for recovering lithium and high value transition metals from spent LIBs. In particular, the present disclosure provides a process route which can directly recover lithium and transition metals using a solid-state pyro-metallurgical process scheme accompanied by subsequent hydro-metallurgical steps.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

Throughout this specification, unless specifically stated otherwise or the context requires otherwise, reference to a single step, composition of matter, group of steps or groups of compositions of matter shall be taken to encompass one and a plurality of those steps, compositions of matter, groups of steps or groups of composition of matter. Thus, as used herein, the singular forms “a”, “an” and “the” include plural aspects unless the context clearly dictates otherwise. Range may be expressed herein as from “about” or “approximately” one particular value and/or to “about” or “approximately” another particular value. When such a range is expressed, other example embodiments include from the one particular value and/or to the other particular value. Furthermore, unless the context clearly requires otherwise, throughout the description and the claims, the words “comprise”, “comprising”, and the like are to be construed in an inclusive sense as opposed to an exclusive or exhaustive sense; that is to say, in the sense of “including but not limited to”.

Unless otherwise defined, all technical and scientific terms used herein have the same meaning as commonly understood by one of ordinary skill in the art to which this invention belongs. Although methods and materials similar or equivalent to those describe herein can be used in the practice or testing of the present disclosure, suitable methods and materials are described below. In case of conflict, the present specification, including definition, will control. In addition, the materials, methods, and examples are illustrative inly and not intended to be limiting.

Furthermore, each example of the present disclosure described herein is to be applied mutatis mutandis to each and every other example unless specifically stated otherwise. The present disclosure is not to be limited in scope by specific examples described herein, which are intended for the purpose of exemplification only. Functionally equivalent products, compositions and methods are clearly within the scope of the disclosure as described herein.

The term “and/or”, e.g., “X and/or Y” shall be understood to mean either “X and Y” or “X or Y” and shall be taken to provide explicit support for both meanings or for either meaning.

### Lithium Nickel Cobalt Manganese Oxide Type Lithium Ion Battery

This embodiment pertains to a method for recovering lithium and transition metals, namely cobalt and nickel, from spent LiNiCoMnO₂ type lithium ion batteries (“NCM LIB”). The residual graphite, recovered from the battery anode, can act as one of the reductants and sources of carbon. Lithium carbonate and cobalt oxide are dissolved as lithium bicarbonate and cobalt carbonate hydroxide using carbon dioxide assisted digestion, and subsequently recovered using evaporative crystallization; cobalt will also precipitate in the form of cobalt carbonate hydrate and convert into cobalt oxide through a heating process, which can either be collected by washing off lithium carbonate or undergo reduction to further convert into its metallic form to be recovered through a magnetic separation scheme. Similarly nickel oxide contained in filtered material is reduced back to metallic form and separated from the insoluble non-magnetic manganese oxide.

As defined in this embodiment, the term “Blass Mass” refers to the solid mixture obtained from prior physical separation procedures, and comprises of spent cathode material compound NCM, as well as trace amounts of graphite from battery anode, copper from battery electrode support and aluminum from battery pack casing. Typical chemical compositions of the Blass Mass from NCM LIB are summarized in Table 1.

Prior to undergoing the processes described herein, physical separation steps including comminution (size reduction), classification and gravity separation may be required to sufficiently liberate the Black Mass from its package inside of the LIB pack. In addition, magnetic separation can be also applied if steel casing is used in the battery packaging. The comminution can be realized by conventional shredding techniques or other processes specifically designed for disintegrating LIB battery packs. The separation of high value Black Mass from debris and particles generated from shredding can be achieved by industrially available gravity and magnetic separators which are well known and developed.

The Black Mass is first mixed with additional carbon, preferably in anthracite coal or other forms of activated carbon. For the purpose of this disclosure, carbon added can comprise graphite, coal, char, and coke and combinations thereof, and can be in solid or gaseous state, with a low percentage of ash composition and volatile matter.

In one preferred embodiment, a minimum of 80% of carbon may be required from the combined source of carbon, with maximum 10% of total ash composition allowed. Sodium, potassium, calcium and magnesium oxides in the ash should be limited to a maximum of 1% combined as they are potential contaminants to lithium carbonate. Iron oxides should also be strictly controlled to less than 0.1% as it may contaminate cobalt or nickel after reduced back to metallic forms.

In certain embodiments, excessive carbon to its stoichiometrically required amount may be added to compensate for the reduced contact between Black Mass and carbon powder due to poor mixing or incompatible powder sizing distribution. Any cobalt or nickel bearing materials recovered from each of the steps along the process are also added to the Black Mass mixture to make up the feedstock. Homogenous particle sizing distribution from each feed material stream is desired for closer contact between solid reactants. The mixing can be facilitated with industry grade powder mixers to achieve uniform distribution of Black Mass and added carbon.

The premixed Black Mass mixture is then sent to a reactor and heated up to 400-600 degrees Celsius. Inert gas can be applied during the heating to avoid unnecessary oxidation of any carbon present. In certain embodiments, the Black Mass powder may have a fine particle sizing distribution; the atmosphere in the reactor is controlled to minimize the dusting. The reactor can be a rotary or fluidized bed reactor or a stationary furnace. In certain embodiments involving a rotary reactor, heat transferred from hot free board gas accounts for the major heat transfer mechanism; whereas in other embodiments using a stationary furnace as the reactor, convection and radiation heat transfer both exist to allow the Black Mass mixture to be heated. Any residual moisture or remaining volatile matter is also removed during the heating. Off gas from the reactor is flared in open air to avoid emission of hazardous carbon monoxide exiting the reactor system.

The fundamental metallurgical essence of the present disclosure is based on the partial decomposing reduction of LiNiCoMnO₂ by carbon, gaseous carbon monoxide or/and hydrogen. Carbon monoxide (and H₂ as applicable) is transferred following a partial pressure gradient to be in contact with the NCM matrix on a molecular level. CO and carbon react with the lithium-bearing compound to form lithium carbonate and the removal of oxygen from lattice in the crystal structure will reduce cobalt and nickel to their lower covalent states and produce cobalt (II) oxide and nickel (II) oxide.

A temperature profile above 400 degrees Celsius should be maintained for the benefit of elevated reaction kinetics. Overheating is highly detrimental to the process due to the formation of undesired chemicals and phases when the temperature reaches beyond 600 degrees Celsius.

It will be appreciated by those skilled in the art that, other things being equal, the higher the temperature, the shorter the reaction time to achieve the desired extent of reaction. Generally, the residence time is set for 1 to 4 hours. The time required for completing such reactions also depends upon the particle size of the Black Mass mixture, the configuration of the reactor, and the reactivity of carbon added.

The ratio of carbon monoxide to carbon dioxide ranging from 1:2 to 2:1 can be selected from to facilitate the partial decomposing reduction. The exiting off gas stream with excessive CO will be further flared to scavenger its heat content as a heat source. Once the hot off gas leaving the heat exchanger is cooled to room temperature, it can be fed to facilitate the washing and dissolution of lithium carbonate, which is further discussed in [0034] and [0038].

As the partial decomposing reduction takes place, cobalt (II) oxide and nickel (II) oxide continue to form within the original oxide lattice of Black Mass. Temperature and reducing conditions should be carefully controlled within their target range, to avoid the formation of intermetallic of cobalt and nickel.

Once cobalt and nickel are converted to their desired oxide forms and lithium is converted to lithium carbonate, heating to the reactor can be stopped and inert gas is applied to quench the reduced Black Mass back to room temperature. Demineralized water is added to wash the reduced Black Mass at room temperature to minimize the dissolution of lithium carbonate formed from the prior reaction step. Residual carbon has a lower density than water and may float to the surface, which can be readily removed using a conventional flotation or settling tank. The removed residual carbon can be dried and recycled back to mix with Black Mass in the feed material.

The heavier mixture is dewatered at elevated temperature from 30-60 degrees Celsius and mixed with fresh demineralized water cooled to a 0-5 degrees Celsius temperature range, to form a slurry stream for extracting lithium carbonate and cobalt oxide from the solid mixture. In various embodiments, the slurry solids content may be from 10-30 wt %. Carbon dioxide gas is used to make contact with the solid mixture under digestion in water. Since the solubility of lithium carbonate increases as the solution temperature drops, the mixed slurry is continuously held at a target temperature range of 0-5 degrees Celsius to promote a strong leaching effect and reduce the consumption of water. In addition, in the presence of CO₂, the lithium carbonate readily dissolves in water in the form of lithium bicarbonate, which is several times more soluble in aqueous solution than lithium carbonate, depending on the temperature of the aqueous solution used. Since the resulting lithium bicarbonate solution has a relatively strong basicity in the range of 8-11, and the solubility of cobalt carbonate/hydroxide increases drastically under such conditions, cobalt oxide can be readily dissolved in such a basic solution and converted into a more soluble cobalt carbonate hydroxide complex.

Mechanical agitation to the slurry is required for enhancing gas-liquid-solid interfacial contact. CO₂ is injected from the bottom of the digestion unit, which may be a conventional digestion tank or vessel, to extend its travelling time to the top of the surface and promote the dissolution of CO₂ to react with dissolved species in the solution. The stoichiometric ratio of the total amount of CO₂ routed for digestion to lithium carbonate present in the slurry may be in a range of 3-10 times, depending on the geometric configuration of the mechanical unit, the leaching temperature, and slurry solid content.

It will be appreciated by those skilled in the art that, other things being equal, the better gas-liquid interfacial contact and more effective CO₂ dissolving into the solution, the less amount of total CO₂ may be required. The CO₂ gas flowrate should be calibrated to evenly supply throughout the entire leaching process.

Typically, the leaching may be performed for 1-6 hours to ensure thorough removal of lithium carbonate and cobalt carbonate hydroxide into solution. It can be appreciated by a person skilled in the field, other things being equal, the shorter the leaching process is, the higher CO₂ gas flowrate and better mixing are required. The resulting solution enriched with lithium bicarbonate and cobalt carbonate hydroxide may be saturated with either lithium bicarbonate or cobalt carbonate hydroxide, depending on the CO₂ partial pressure and solution temperature.

In one embodiment, the gaseous environment may be filled with pure CO₂ and maintained at a pressure higher than atmospheric level, allowing for achievement of higher solubility of CO₂ to enhance the overall leaching efficiency. The sludge from the tailings, which contains mostly nickel oxide and manganese oxide, will be filtered and collected for drying and feeding for next step of full reduction.

The dried oxide mixture is mixed with recycled carbon from [0033] and then sent to a reactor and heated up to 650-800 degrees Celsius. Inert gas can be applied during the heating to avoid unnecessary oxidation of any carbon present. Again, the reactor can be a rotary or fluidized bed reactor or a stationary furnace. In certain embodiments involving a rotary reactor, heat transferred from hot free board gas accounts for the major heat transfer mechanism; whereas in other embodiments using a stationary furnace as the reactor, convection and radiation heat transfer both exist to allow the solid mixture to be heated. Any residual moisture can also be removed during the heating. Off gas from the reactor is flared in open air to avoid emission of hazardous carbon monoxide exiting the reactor system.

The fundamental metallurgical essence of the present disclosure is based on the complete reduction of nickel oxide by carbon, gaseous carbon monoxide or/and hydrogen. Carbon monoxide (and H₂ as applicable) is transferred following a partial pressure gradient to be in contact with the nickel oxide on a molecular level. The complete removal of oxygen from oxide will reduce nickel to its metallic form as a stable product. Again, manganese oxide will remain unreacted as a result of its higher stability and thus increasing difficulty to be reduced.

A temperature profile above 650 degrees Celsius should be maintained for the benefit of elevated reaction kinetics. Overheating is highly detrimental to the process due to the formation of undesired compounds and phases when the temperature reaches beyond 800 degrees Celsius.

It will be appreciated by those skilled in the art that, other things being equal, the higher the temperature, the shorter the reaction time to achieve the desired extent of reaction. Generally, the residence time is set for 2 to 8 hours. The time required for completing such reactions also depends upon the particle size of the solid oxide mixture, the configuration of the reactor, and the reactivity of carbon added.

It should also be appreciated that mentioning of CO/CO₂ gas mixture does not preclude the use of other reducing/oxidizing gas pairs, such as H₂/H₂O, or a combination of them in any ratio thereof. The ratio of carbon monoxide to carbon dioxide (and H₂ to H₂O ratio, if added to the reduction) ranging from 1:1 to 4:1 can be selected from to facilitate the complete reduction. The exiting off gas stream with excessive CO will be further flared to scavenge its heat content as a heat source. Once the hot off gas leaving the heat exchanger is cooled to room temperature, it can be fed to facilitate the washing and dissolution of lithium carbonate and cobalt carbonate hydroxide complex, which is further discussed in [0034] and [0038].

As the complete reduction takes place, the metallic nickel formed continues to grow in grain size and congregate into a pure metal phase. It is critical for the metallic grain size to grow sufficiently, which can be managed by controlling the reaction temperature and duration of exposure under the target temperature. Moderately fine grain and consistent metallic grain sizing distribution are key to subsequent separation and recovery.

Once nickel oxide is reduced completely, heating to the reactor can be stopped and inert gas is applied to quench the reduced oxide mixture back to room temperature. Demineralized water is added to mix with the reduced oxide mixture at room temperature to prepare it for the subsequent magnetic separation.

In certain embodiments, the slurry may have a solid density in a range of 10-30 wt %. The slurry gathered will be directed to a wet magnetic separator for recovering the magnetic metallic nickel. Two passes of magnetic separation of weak to immediate magnetic strength, ranging from 50 mT-500 mT are applied to the downward travelling slurry stream to obtain a head stream of metallic nickel concentrate.

In certain embodiments, the first pass of magnetic separation may be at a magnetic strength of 100-200 mT and the second pass may be preferably controlled at a magnetic strength of 200-400 mT, to ensure gradual and thorough separation of magnetic nickel particles from non-magnetic substances.

It will be appreciated by a person skilled in the field that, the magnetic strength used for each pass will be dependent on number of stages of magnetic separation applied. In principle, the weaker the magnetic strength, the more passes may be required to achieve the same level of separation. In a particular embodiment, one pass of magnetic separation at 50-100 mT may be sufficient when the metallic particles are sufficiently fine and liberated.

Mechanical vibration is also applied during the separation process to improve the separability of the slurry mixture. The magnetic strength required at the wet magnetic separator primarily depends on the particle sizing distribution of metallic nickel, the physical configuration of the separator, and the water flow rate used for carrying the slurry.

The head stream of concentrated metallic nickel is collected and dried in inert gas at around 50-80 degrees Celsius to avoid re-oxidation. An anti-oxidizing agent is added to the fresh deionized water, before mixing with the head metallic stream, to prevent re-oxidation of metallic nickel. Metallic nickel is then stored in proper conditions as one of the final products.

After the solution enriched with lithium carbonate and cobalt carbonate hydroxide is drained from the digestion unit, it is sent to undergo evaporative crystallization to recover high purity cobalt carbonate and lithium carbonate. The evaporation unit may be a conventional hot crystallizer or other commercially available evaporative crystallizers, and the precipitation can take place in either a one or two-step fashion. The temperature of crystallization can be set to 60-90 degrees Celsius to provide a sufficient amount of heat without excessive boiling which may disrupt the crystallization and the settling of crystals formed. As the temperature of the lithium-bearing solution rises, the solubility of CO₂ decreases, which removes CO₂ from the solution system thus reversing the carbonate-bicarbonate reaction. Also, the reduction in lithium carbonate solubility will promote its precipitation. Lastly, heating up the solution removes excess water, which accelerates the precipitation of lithium carbonate. Meanwhile, the pH of the solution drops as the concentration of bicarbonate decreases, resulting in the reduced solubility of cobalt carbonate hydroxide complex. The evaporative crystallization may be performed for 4-12 hours, depending on the ambient temperature, the concentration of the solution and amount of impurities present.

Accompanied by the evolution of CO₂ gas, the solubility of lithium carbonate and cobalt carbonate hydroxide decreases drastically, and the crystal structure starts to grow rapidly. As the evaporation is near complete, a thick layer of white lithium carbonate and purple cobalt carbonate hydrate crystal settles down to the bottom of the crystallizer. In a preferred embodiment, the circulation of hot liquid is slower and less turbulent; a bed of crystals may form as a result of steady and quiescent settling. Mild agitation may be applied to shatter the crystal bed after precipitation, restoring it back to a thick liquor state that is easier to discharge.

The dewatered solid crystal now comprises of lithium carbonate as well as mixture of cobalt carbonate hydrate. In certain embodiments, additional heating is applied during the evaporation step and may cause cobalt carbonate hydroxide to dehydrate and remain as cobalt carbonate instead.

In certain embodiments, continued heating beyond 400 degree Celsius and below 700 degree Celsius is applied to the mixture after drying of the crystal and dehydration of cobalt carbonate, to further thermally decompose cobalt carbonate into cobalt (II) oxide and carbon dioxide. N₂ or Ar gas is used to maintain an inert gas atmosphere to avoid formation of other forms of cobalt oxide. The heating can be applied for 1-4 hours to drive away the CO₂ and inert gas is injected to quench the mixture back to room temperature.

In certain embodiments where cobalt oxide is the preferred product, cold demineralized water, with temperature in the range of 0-5 degree Celsius, is used to wash off the lithium carbonate via a digestion step similar to [0034] to [0036], without injection of CO₂. Since cobalt oxide is essentially insoluble in water, it will settle at the bottom of the tank by gravity and form a sludge stream which is then dewatered, dried and collected as one of the final products, cobalt (II) oxide. The solution carrying lithium carbonate is then sent to undergo evaporative crystallization similar to procedures described in [0051] to [0052].

In other embodiments where metallic cobalt is the preferred product, before the quenching of inert gas to cool the material down, the mixture of lithium carbonate and cobalt oxide is sent to undergo a complete reduction step similar to [0039], to reduce the cobalt from its oxide form back to metallic cobalt. The temperature range should be from 600-750 degree to promote faster reaction kinetics and higher energy efficiency, and the residence time is set for 2-8 hours to allow complete reduction to take place.

Once reduction of cobalt is complete, the mixture of cobalt and lithium carbonate is cooled in inert gas to avoid re-oxidation. To further separate cobalt metal and lithium carbonate, magnetic separation procedures similar to [0046] to [0048] are subsequently applied to the cooled mixture. Metallic cobalt concentrated in the head stream is then dried and collected as one of the final products, whereas the non-magnetic tailing stream, which contains lithium carbonate, is also dewatered and dried.

Crystal lithium carbonate is collected from all sources described above, as one of the final products, with a purity of min. 95% of anhydrous lithium carbonate equivalent, with trace amount of impurities of cobalt, cobalt oxides, sodium, potassium and calcium carbonate. To improve purity of the resultant lithium carbonate, recrystallization and other conventional purification techniques can be applied to reduce the level of impurities to the range of 0.1-1%. However, the upgrading of lithium carbonate from hereon is not the scope of this present disclosure and is therefore excluded.

### EXAMPLES

Various aspects of the disclosed solution may be still more fully understood from the following description of some example implementations and corresponding results. Some experimental data is presented herein for purpose of illustration and should not be construed as limiting the scope of the disclosed technology in any way or excluding any alternative or additional embodiments.

### Example 1

A first example of certain implementations of the disclosed technology and corresponding results will now be disclosed with respect to Black Mass separated from a spent NCM LIB pack at 87.5 wt % lithium cobalt oxide with balance amount of graphite and no entrained copper, aluminum or steel debris, that was treated for the recovery of lithium, cobalt, nickel and manganese, with metallic cobalt as the cobalt containing product. Details of compositions of Black Mass from a typical spent NCM LIB can be found in Table 1.

20 to 80 g of the Black Mass feed material was first mixed with additional activated carbon powder using a mechanical powder mixer in a 4:1 to 5:1 mass ratio.

The well-mixed Black Mass mixture was then heated up in inert argon gas to 400 degrees Celsius and a gas flow mixed with CO/CO₂ in a 2:1 volumetric ratio was added at 100-600 mL/min to react with the heated Black Mass. The average residence time of the CO/CO₂ gas mixture was in a range of 1-5 mins.

A constant temperature of 450-550 degrees Celsius and constant flow of CO/CO₂ gas mixture were maintained for 2-4 hours to allow the partial reduction to take place sufficiently. After the heating was stopped, CO/CO₂ gas flow was replaced by inert argon gas to cool down the reduced Black Mass. During the partial reduction, cobalt and nickel from lithium nickel cobalt manganese oxide was readily reduced to cobalt oxide and nickel oxide. In the meantime, lithium contained in nickel cobalt manganese oxide was converted to lithium carbonate. Residual carbon may exist in the reduced Black Mass mixture, which was around 5-10 wt % and minimally 95% of cobalt should be converted to cobalt oxide.

After cooling, washing water was adjusted to 20-30 degrees Celsius before it was added to the reduced Black Mass. Lighter carbon floated to the top of the water surface, whereas the heavier mixture of cobalt oxide, nickel oxide, manganese oxide and lithium carbonate, settled down at the bottom, along with trace amounts of impurities introduced through the added carbon.

The tailing from the previous gravity separation step was sent for CO₂ digestion. 500 mL to 2.5 L of demineralized water was cooled to 0-2 degrees Celsius prior to its addition to the solid mixture, to achieve maximal solubility of lithium carbonate and lithium bicarbonate. CO₂ gas was added to the solid/liquid mixture at a flow rate of 100-150 mL/min, in order to promote the digestion of lithium carbonate and convert it into the more soluble lithium bicarbonate. The temperature was controlled at 0 degrees Celsius and continuous CO₂ gas flow was maintained for 1-3 hours.

After adequate leaching was performed, the solution enriched of lithium bicarbonate and cobalt carbonate hydroxide was separated from the remaining solid using a vacuum filtration technique to ensure complete liquid transfer. The clear lithium-bearing solution was then applied for evaporative crystallization at a constant temperature of 60-80 degrees Celsius. Heat was supplied steadily and the temperature of the solution quickly rose from near 0 degrees Celsius to around 60 degrees Celsius. The evaporative crystallization was conducted for approximately 6-10 hours for lithium carbonate to precipitate steadily and to allow slow crystal growth. By the end of the crystallization, a mixture of white and purple crystal precipitated onto the bottom of the container.

The remaining insoluble solid mixture separated from the previous filtration step was again mixed with additional activated carbon powder using a mechanical powder mixer in a 2.5:1 to 3:1 mass ratio. The mixed material was heated up in inert argon gas to 750 degrees Celsius and a gas flow mixed with CO/CO₂ in a 4:1 volumetric ratio was added at 100-600 mL/min to react with the heated solid mixture. The average residence time of the CO/CO₂ gas mixture was in a range of 1-5 mins.

A constant temperature of 750-800 degrees Celsius and constant flow of CO/CO₂ gas mixture were maintained for 3-6 hours to allow the reduction of nickel to take place completely. After the heating was stopped, CO/CO₂ gas flow was replaced by inert argon gas to cool down the reduced nickel along with manganese oxide. During the complete reduction, nickel from lithium nickel cobalt manganese oxide and nickel oxide was readily reduced to metallic nickel. In the meantime, manganese was not reduced and remained in its oxide form. Residual carbon may exist in the reduced solid mixture, which was around 10-25 wt % and a metallization of 95% of nickel can be achieved.

Afterwards, the cooled mixture of nickel and manganese oxide was sent for wet magnetic separation in two passes. The first pass of magnetic separation was set at 100 mT to recover the majority of the metallic nickel, and the tailing from the first pass was sent for a second pass of magnetic separation, which was set at 200 mT, to scavenge residual nickel. Metallic nickel collected from the two passes of magnetic separation was combined into one slurry stream and the tailing from the second pass was also collected. The tailing was then dried to obtain manganese oxide

The crystal mixture of lithium carbonate and cobalt carbonate hydrate were further heated up to 400 degrees Celsius in Ar gas, for cobalt carbonate hydrate to undergo decomposition and form cobalt oxide. The heating was maintained for 1-3 hours at target temperature.

In this example, the cobalt oxide resulting from thermal decomposition and lithium carbonate were further heated to 700 degrees Celsius in Ar gas, and a gas flow mixed with CO/CO₂ in a 4:1 volumetric ratio was added at 100-600 mL/min to react with the heated solid mixture. The average residence time of the CO/CO₂ gas mixture was in a range of 1-5 mins.

A constant temperature of 700-750 degrees Celsius and constant flow of CO/CO₂ gas mixture were maintained for 3-6 hours to allow the reduction of cobalt to take place completely. After the heating was stopped, CO/CO₂ gas flow was replaced by inert argon gas to cool down the reduced cobalt along with lithium carbonate. During the complete reduction, cobalt from cobalt oxide was readily reduced to metallic cobalt. In the meantime, lithium was not reduced and remained in its carbonate form. As a result, a metallization of 95% of cobalt can be achieved.

Afterwards, the cooled mixture of cobalt and lithium carbonate was sent for wet magnetic separation in two passes. The first pass of magnetic separation was set at 100 mT to recover the majority of the metallic cobalt, and the tailing from the first pass was sent for a second pass of magnetic separation, which was set at 200 mT, to scavenge residual cobalt. Metallic cobalt collected from the two passes of magnetic separation was combined into one slurry stream and the tailing from the second pass was also collected along with washing water used.

The tailing containing lithium carbonate crystals was combined with washing water collected after magnetic separation of cobalt, and the mixed stream was then heated under temperature of 60-80 degree Celsius for drying and to allow lithium carbonate crystals to form again. The evaporative crystallization was conducted for approximately 6-10 hours for lithium carbonate to precipitate steadily and to allow slow crystal growth; and a high purity of >90% was achieved in the lithium carbonate recovered.

### Example 2

A second example of certain implementations of the disclosed technology and corresponding results will now be disclosed with respect to Black Mass separated from a spent NCM LIB pack at 87.5 wt % lithium cobalt oxide with balance amount of graphite and no entrained copper, aluminum or steel debris, that was treated for the recovery of lithium, cobalt, nickel and manganese, with cobalt oxide as the cobalt containing product instead. Sample preparation and procedures were the same as those described in step [0061] to [0070]

In this example, the cobalt oxide resulting from thermal decomposition and lithium carbonate were cooled down back to room temperature in Ar gas. The cooled solid mixture was washed with cold demineralized water to wash off lithium carbonate away from cobalt oxide. 2 L to 10 L of demineralized water was cooled to 0-2 degrees Celsius prior to its addition to the solid mixture, to achieve maximal solubility of lithium carbonate. Mechanical stirring/agitation was also applied to improve the mixing between the solid material and water added.

After adequate washing was performed, the washing water carrying lithium carbonate was separated from the remaining solid using a vacuum filtration technique to ensure complete liquid transfer. The clear lithium-bearing solution was then applied for evaporative crystallization at a constant temperature of 60-80 degrees Celsius. Heat was supplied steadily and the temperature of the solution quickly rose from near 0 degrees Celsius to around 60 degrees Celsius. The evaporative crystallization was conducted for approximately 6-10 hours for lithium carbonate to precipitate steadily and to allow slow crystal growth, and a high purity of >90% was achieved in the lithium carbonate recovered.

### Lithium-Cobalt Oxide or Lithium-Nickel Oxide Type Lithium Ion Battery

This embodiment pertains to a method for recovering lithium and transition metals, namely cobalt and nickel, from spent LiCoO₂ and LiNiO₂ type lithium ion batteries (“LCO LIB” and “LNO LIB” respectively). The residual graphite recovered from the battery anode, can act as one of the reductants and source of carbon. Lithium carbonate which forms from the lithium recovery procedure is then purified using carbon dioxide assisted digestion and subsequently recovered using evaporative crystallization; metallic cobalt or nickel is collected through a magnetic separation scheme.

As defined in this embodiment, the term “Blass Mass” refers to the solid mixture obtained from prior physical separation procedures, and comprises of spent cathode material compound LCO or LNO, as well as trace amounts of graphite from battery anode, copper from battery electrode support and aluminum from battery pack casing. Typical chemical compositions of the Blass Mass from LCO and LNO LIB are summarized in Tables 2 and 3 respectively.

Prior to undergoing the processes described herein, physical separation steps including comminution (size reduction), classification and gravity separation may be required to sufficiently liberate the Black Mass from its package inside of the LIB pack. In addition, magnetic separation can be also applied if steel casing is used in the battery packaging. The comminution can be realized by conventional shredding techniques or other processes specifically designed for disintegrating LIB battery packs. The high value Black Mass separation from debris and particles generated from shredding can be achieved by industrially available gravity and magnetic separators which are well known and developed.

The Black Mass is first mixed with additional carbon, preferably in anthracite coal or other forms of activated carbon. For the purpose of this disclosure, carbon added can comprise coal, char, and coke and combinations thereof, and can be in solid or gaseous state, with a low percentage of ash composition and volatile matter.

In one preferred embodiment, a minimum of 80% of carbon may be required from the selected source of carbon, with maximum 10% of total ash composition allowed. Sodium, potassium, calcium and magnesium oxides in the ash should be limited to a maximum of 1% combined as they are potential contaminants to lithium carbonate. Iron oxides should also be strictly controlled to less than 0.1% as it may contaminate cobalt or nickel after reduced back to metallic forms.

In certain embodiments, excessive carbon to its stoichiometrically required amount may be added to compensate for the reduced contact between Black Mass and carbon powder due to poor mixing or incompatible powder sizing distribution.

Any cobalt or nickel bearing materials recovered from each of the steps along the process are also added to the Black Mass mixture to make up the feedstock. Homogenous particle sizing distribution from each feed material stream is desired for closer contact between solid reactants. The mixing can be facilitated with industry grade powder mixers to achieve uniform distribution of Black Mass and added carbon. Conventional powder pressing techniques such as pelletizing, agglomeration or briquetting can be applied to increase the physical contact between the added carbon and Black Mass for improved chemical reaction dynamics.

The premixed Black Mass mixture is then sent to a reactor and heated up to 650-750 degrees Celsius. Inert gas can be applied during the heating to avoid unnecessary oxidation of any carbon present. In certain embodiments, the Black Mass powder may have a fine particle sizing distribution; the atmosphere in the reactor is controlled to minimize the dusting. The reactor can be a rotary reactor or a stationary furnace. In certain embodiments involving a rotary reactor, heat transferred from hot overboard gas accounts for the major heat transfer mechanism; whereas in other embodiments using a stationary furnace as the reactor, convection and radiation heat transfer both exist to allow the Black Mass mixture to be heated. Any residual moisture or remaining volatile matter is also removed during the heating. Off gas from the reactor is flared in open air to avoid emission of hazardous carbon monoxide exiting the reactor system.

The fundamental metallurgical essence of the present disclosure is based on the reductive decomposition reaction of LiCoO₂ or LiNiO₂ directly by elemental carbon, gaseous carbon monoxide or/and hydrogen. Carbon monoxide (and H₂ as applicable) is transferred following a partial pressure gradient to be in contact with the LCO or LNO matrix on a molecular level. CO and carbon react with the lithium-bearing compound to form lithium carbonate and the reduction of oxides of transition metals produces metallic form of cobalt or nickel as the result.

After the reaction between carbon monoxide and lithium cobalt or lithium nickel oxides, cobalt (II) oxide or nickel (II) oxide immediately reacts with in situ carbon monoxide to be readily reduced to their metallic forms. Moreover, a temperature profile above 650 degrees Celsius should be maintained for the benefit of elevated reaction kinetics. Overheating is also highly detrimental to the process due to the formation of undesired compounds and phases when the temperature reaches beyond 800 degrees Celsius.

It will be appreciated by those skilled in the art that, other things being equal, the higher the temperature, the shorter the reaction time to achieve the desired extent of reaction. Generally, the residence time is set for 2 to 8 hours. The time required for completing such reactions also depends upon the particle size of the Black Mass mixture, the configuration of the reactor, and the reactivity of carbon added.

It should also be appreciated that mentioning of CO/CO₂ gas mixture does not preclude the use of other reducing/oxidizing gas pairs, such as H₂ to H₂O, or a combination of them in any ratio thereof. The ratio of carbon monoxide to carbon dioxide (and H₂ to H₂O ratio, if added to the reduction) ranging from 1:2 to 4:1 can be selected from to facilitate the reductive decomposition. For the purpose of this disclosure, the optimal range of gas composition lies from 1:1 to 2:1 CO/CO₂ volumetric ratios. The exiting off gas stream with excessive CO will be further flared to recover its heat content, which may later be used to heat up the feed material. Once the hot off gas leaving the heat exchanger is cooled to room temperature, it can be fed to facilitate the washing and dissolution of lithium carbonate, which is further discussed in [0038] and [0042].

As the reductive decomposition takes place, metallic cobalt or nickel formed continues to grow in grain size and congregate into a pure metal phase. It is critical for the metallic grain size to grow sufficiently, which can be managed by controlling the reaction temperature and duration of exposure under the target temperature. Moderately fine grain and consistent metallic grain sizing distribution is conducive to subsequent separation and recovery.

Once cobalt or nickel oxide is reduced and lithium is converted to lithium carbonate, heating to the reactor can be stopped and inert gas is applied to quench the reduced Black Mass back to room temperature. Demineralized water is added to wash the reduced Black Mass at room temperature to minimize the dissolution of lithium carbonate formed from the prior reductive decomposition. Residual carbon has a lower density than water and may float to the surface, which can be readily removed using a conventional flotation or settling tank. The removed residual carbon can be dried and recycled back to mix with Black Mass in the feed material.

In certain embodiments, the slurry may have a solid density in a range of 10-30 wt %. The slurry gathered will be directed to a wet magnetic separator for recovering the ferro-magnetic metallic cobalt and/or nickel. Two passes of magnetic separation of weak to immediate magnetic strength, ranging from 50 mT-500 mT are applied to the downward travelling slurry stream to obtain a head stream of metallic cobalt or nickel concentrate.

In certain embodiments, the first pass of magnetic separation may be at a magnetic strength of 100-200 mT and the second pass may be preferably controlled at a magnetic strength of 200-400 mT, to ensure gradual and thorough separation of magnetic cobalt or nickel particles from non-magnetic substances.

It will be appreciated by a person skilled in the field that, the magnetic strength used for each pass will be dependent on number of stages of magnetic separation applied. In principle, the weaker the magnetic strength, the more passes may be required to achieve the same level of separation. In a particular embodiment, one pass of magnetic separation at 50-100 mT may be sufficient when the metallic particles are sufficiently fine and liberated.

Mechanical vibration is also applied during the separation process to improve the separability of the slurry mixture. The magnetic strength required at the wet magnetic separator primarily depends on the particle sizing distribution of metallic cobalt or nickel, the physical configuration of the separator, and the water flow rate used for carrying the slurry.

The non-magnetic tailing stream is dewatered at elevated temperature from 30-60 degrees Celsius and mixed with fresh demineralized water cooled to a 0-5 degrees Celsius temperature range, to form a slurry stream for extracting lithium carbonate from the solid mixture. In various embodiments, the slurry solids content may be from 10-30 wt %. Carbon dioxide gas, including that recycled from the reactor after cooling down to room temperature, is used to make contact with the non-magnetic tailing under digestion in water. Since the solubility of lithium carbonate increases as the solution temperature drops, the mixed slurry is continuously held at a target temperature range of 0-5 degrees Celsius to promote a strong leaching effect and reduce the consumption of water. In addition, in the presence of CO₂, the lithium carbonate readily dissolves in water in the form of lithium bicarbonate, which is several times more soluble in aqueous solution than lithium carbonate, depending on the temperature of the aqueous solution used.

Mechanical agitation to the slurry is required for enhancing gas-liquid-solid interfacial contact. CO₂ is injected from the bottom of the digestion unit, which may be a conventional digestion tank or vessel, to extend its travelling time to the top of the surface and promote the dissolution of CO₂ to react with dissolved species in the solution. The stoichiometric ratio of the total amount of CO₂ routed for digestion to lithium carbonate present in the slurry may be in a range of 3-10 times, depending on the geometric configuration of the mechanic unit, the leaching temperature, and slurry solid content.

It will be appreciated by those skilled in the art that, other things being equal, the better gas-liquid interfacial contact and more effective CO₂ dissolving into the solution, the less amount of total CO₂ may be required. The CO₂ gas flowrate should be calibrated to evenly supply throughout the entire leaching process.

Typically, the leaching may be performed for 1-6 hours to ensure thorough removal of lithium carbonate into solution. It can be appreciated by a person skilled in the field, other things being equal, the shorter the leaching process is, the higher CO₂ gas flowrate is required. The resulting solution saturated in lithium bicarbonate may contain lithium bicarbonate in a range of 5-20 wt %, depending on the solution temperature and CO₂ partial pressure.

In one embodiment, the gaseous environment may be filled with pure CO₂ and maintained at a pressure higher than atmospheric level, allowing for achievement of higher solubility of CO₂ to enhance the overall leaching efficiency. The sludge from the tailings, which contains mostly unreacted lithium cobalt oxide or lithium nickel oxide, will be collected for drying and recycling as part of feed material added to fresh Black Mass.

The head stream of concentrated metallic cobalt or nickel is collected and dried in inert gas at around 50-80 degrees Celsius to avoid re-oxidation. An anti-oxidizing agent is added to the fresh deionized water, before mixing with the head metallic stream, to prevent re-oxidation of metallic cobalt and nickel.

In a particular embodiment, in the case which Black Mass from spent LNO LIB is recycled, a higher drying temperature may be applied during the drying and less protection against oxidization may be required, as metallic nickel is less prone to re-oxidation in the presence of air or oxygen than LCO LIB.

For reduced Black Mass with cobalt or nickel not sufficiently liberated from lithium-bearing compound, a considerable amount of lithium carbonate may be trapped within the transition metal dominant matrix in the metallic stream and requires additional steps to purify and at the meanwhile to recover lithium. Similar steps from [0038] and [0042] can be applied to the concentrated metallic stream, to yield metallic cobalt or nickel with higher purity and residual amount of lithium carbonate to improve the overall recovery.

It will be appreciated by those skilled in the art that, depending on the state of non-metallic cobalt present in the metallic head stream and the non-magnetic tailing stream, certain cobalt compounds with various solubilities may be present in the aqueous lithium bicarbonate solution and carried forward with the host solution to the next steps. In certain embodiments, trace amounts, ranging from 0.1% to 1%, of cobalt carbonate or cobalt hydroxide may be present in the solution, which requires further purification during and after evaporative crystallization.

After the lithium bicarbonate rich solution is drained from the leaching unit, it is sent to undergo evaporative crystallization to recover high purity lithium carbonate. The evaporation unit may be a conventional hot crystallizer or other commercially available evaporative crystallizers. The temperature of crystallization can be set to 60-90 degrees Celsius to provide a sufficient amount of heat without excessive boiling which may disrupt the crystallization and the settling of lithium carbonate crystals formed. As the temperature of the lithium-bearing solution rises, the solubility of CO₂ decreases, which removes CO₂ from the solution system thus reversing the carbonate-bicarbonate reaction. Also, the reduction in lithium carbonate solubility will promote its precipitation. Lastly, heating up the solution removes excess water, which accelerates the precipitation of lithium carbonate. The evaporative crystallization may be performed for 4-12 hours, depending on the ambient temperature, the concentration of the solution and amount of impurities present.

As the solubility of lithium carbonate decreases drastically beyond 10-20 degrees Celsius, its crystal structure starts to grow rapidly, it settles down to the bottom of the crystallizer to form a layer of lithium carbonate crystals. In a preferred embodiment, the circulation of hot liquid is slower and less turbulent; a bed of crystal lithium carbonate may form as a result of steady and quiescent settling. Mild agitation may be applied to shatter the crystal bed of lithium carbonate, restoring it back to a thick liquor state that is easier to transport.

The dewatered solid crystal can be collected with a purity of 95% of anhydrous lithium carbonate equivalent, with trace amount of impurities of cobalt, cobalt oxides, sodium, potassium and calcium carbonate. To improve purity of the resultant lithium carbonate, recrystallization and other conventional purification techniques can be applied to reduce the level of impurities to the range of 0.1-1%. However, the upgrading of lithium carbonate from hereon is not the scope of this present disclosure and therefore is not included.

Impurities removed from different stages of process will be screened for cobalt and nickel content, and material streams bearing cobalt or nickel higher than 65 wt % may be collected and fed back to mix with fresh Black Mass as feed material.

### EXAMPLES

Various aspects of the disclosed solution may be still more fully understood from the following description of some example implementations and corresponding results. Some experimental data is presented herein for purpose of illustration and should not be construed as limiting the scope of the disclosed technology in any way or excluding any alternative or additional embodiments.

### Example 1

A first example of certain implementations of the disclosed technology and corresponding results will now be disclosed with respect to Black Mass separated from a spent LCO LIB pack at 87.5 wt % lithium cobalt oxide with balance amount of graphite and no entrained copper, aluminum or steel debris, that was treated for lithium and cobalt recovery. Details of compositions of Black Mass from a typical spent LCO LIB can be found in Table 1.

20 to 80 g of the Black Mass feed material was first mixed with additional activated carbon powder using a mechanical powder mixer in a 2.5:1 to 4:1 mass ratio.

The well-mixed Black Mass mixture was then heated up in inert argon gas to 710 degrees Celsius and a gas flow mixed with CO/CO₂ in a 4:1 volumetric ratio was added at 100-600 mL/min to react with the heated Black Mass. The average residence time of the CO/CO₂ gas mixture was in a range of 1-5 mins.

A constant temperature of 650-700 degrees Celsius and constant flow of CO/CO₂ gas mixture were maintained for 3-6 hours to allow the reductive decomposition to take place completely. After the heating was stopped, CO/CO₂ gas flow was replaced by inert argon gas to cool down the reduced Black Mass. During the reductive decomposition, cobalt from lithium cobalt oxide was readily reduced to metallic cobalt. In the meantime, decomposed lithium cobalt oxide was converted to lithium carbonate. Residual carbon may exist in the reduced Black Mass mixture, which was around 10-30 wt %. A cobalt metallization of 80%-95% was achieved during the reductive decomposition.

After cooling, washing water was adjusted to 20-30 degrees Celsius before it was added to the reduced Black Mass. Lighter carbon floated to the top of the water surface, whereas heavier metallic cobalt, lithium carbonate and cobalt oxides, including unreacted lithium cobalt oxide, settled down at the bottom, along with trace amounts of impurities introduced through the added carbon.

The tailing from the previous gravity separation step was sent for wet magnetic separation in two passes. The first pass of magnetic separation was set at 100 mT to recover the majority of the metallic cobalt, and the tailing from the first pass was sent for a second pass of magnetic separation, which was set at 200 mT, to scavenge residual cobalt. Metallic cobalt collected from the two passes of magnetic separation was combined into one slurry stream and the tailing from the second pass was also collected.

500 mL to 2.5 L of demineralized water was cooled to 0-2 degrees Celsius prior to its addition to the head stream and tailing stream, to achieve maximal solubility of lithium carbonate and lithium bicarbonate. CO₂ gas was added to the solid/liquid mixture at a flow rate of 100-150 mL/min, in order to promote the digestion of lithium carbonate and convert it into the more soluble lithium bicarbonate. The temperature was controlled at 0 degrees Celsius and continuous CO₂ gas flow was maintained for 90-120 mins.

After adequate leaching was performed, the lithium-bearing solution was separated from the remaining solid using a vacuum filtration technique to ensure complete liquid transfer. The clear lithium-bearing solution was then applied for evaporative crystallization at a constant temperature of 60-80 degrees Celsius. Heat was supplied steadily and the temperature of the solution quickly rose from near 0 degrees Celsius to around 60 degrees Celsius. The evaporative crystallization was conducted for approximately 8-12 hours for lithium carbonate to precipitate steadily and to allow slow crystal growth.

The same steps were carried out for the head stream obtained from magnetic separation to digest any residual lithium carbonate carried over in the metallic cobalt. It is to be appreciated that similar parameters may be applied to magnetic head stream, the main difference to the head stream, and embodiments thereof described herein, are the potential formation and dissolution of slightly soluble cobalt compounds into the clear lithium-bearing solution.

For example, cobalt hydroxide may be slightly soluble at pH level of the lithium-bearing solution and therefore can potentially decompose into cobalt oxide upon evaporative crystallization. In the case that a small amount of cobalt oxide is present in the crystal lithium carbonate produced, gravity separation was applied to remove the cobalt oxide, which has as density of 6.44 kg/m³, from lighter lithium carbonate, which has a density of 2.11 kg/m³.

Lithium carbonate collected from the head and tailing streams were combined and a high purity of >90% was achieved in the lithium carbonate recovered. Cobalt oxide removed from the impurities was stored, which can be fed back to the fresh Black Mass to make up the feedstock. Similarly, carbon recovered along the process was also collected for the potential benefits of reuse.

### Example 2

In the second example, the efficacy of treating Black Mass separated from LNO LIB using the disclosed technology was quantitatively tested, and corresponding results were disclosed accordingly. Details of compositions of Black Mass from a typical spent LNO LIB can be found in Table 2.

20 to 80 g of the Black Mass feed material was first mixed with additional activated carbon powder using a mechanical powder mixer in a 2.5:1 to 4:1 mass ratio.

The well-mixed Black Mass mixture was then heated up in inert argon gas to 810 degrees Celsius and a gas flow mixed with CO/CO₂ in a 4:1 volumetric ratio was added at 100-600 mL/min to react with the heated Black Mass. The average residence time of the CO/CO₂ gas mixture was in a range of 1-5 mins.

A constant temperature of 750-800 degrees Celsius and constant flow of CO/CO₂ gas mixture were maintained for 3-6 hours to allow the reductive decomposition to take place completely. After the heating was stopped, CO/CO₂ gas flow was replaced by inert argon gas to cool down the reduced Black Mass. During the reductive decomposition, nickel from lithium nickel oxide was readily reduced to metallic nickel. In the meantime, decomposed lithium nickel oxide was converted to lithium carbonate. Residual carbon may exist in the reduced Black Mass mixture, which was around 10-30 wt %. A nickel metallization of 85%-95% was achieved during the reductive decomposition.

After cooling, washing water was adjusted to 20-30 degrees Celsius before it was added to the reduced Black Mass. Lighter carbon floated to the top of the water surface, whereas heavier metallic nickel, lithium carbonate and nickel oxides, including unreacted lithium nickel oxide, settled down at the bottom, along with trace amounts of impurities introduced through the added carbon.

The tailing from the previous gravity separation was sent for wet magnetic separation. One pass of magnetic separation was set at 100 mT to recover magnetically active nickel powder. Metallic nickel collected from the wet magnetic separator was settled into slurry stream and the tailing from was also collected for settling.

500 mL to 2.5 L of demineralized water was cooled to 0-2 degrees Celsius prior to its addition to the head stream and tailing stream, to achieve maximal solubility of lithium carbonate and lithium bicarbonate. CO₂ gas was added to the solid/liquid mixture at a flow rate of 100-150 mL/min, in order to promote the digestion of lithium carbonate and convert it into the more soluble lithium bicarbonate. The temperature was controlled at 0 degrees Celsius and continuous CO₂ gas flow was maintained for 90-120 mins.

After adequate leaching was performed, the lithium-bearing solution was separated from the remaining solid using a vacuum filtration technique to ensure complete liquid transfer. The clear lithium-bearing solution was then applied for evaporative crystallization at a constant temperature of 60-80 degrees Celsius. Heat was supplied steadily and the temperature of the solution quickly rose from near 0 degrees Celsius to around 60 degrees Celsius. The evaporative crystallization was conducted for approximately 8 hours for lithium carbonate to precipitate steadily and to allow slow crystal growth.

The same steps were carried out for the head stream obtained from magnetic separation to digest any residual lithium carbonate carried over in the metallic nickel.

Lithium carbonate collected from the head and tailing streams were combined and a high purity of >90% was achieved in the lithium carbonate recovered. Carbon recovered along the process was also collected for the potential benefits of reuse.

We claim:

1. A process for recovering lithium and transition metals, namely cobalt and nickel for spent NCM LIBs, from Black Mass powders physically separated from other parts and materials of used battery packs, comprising:
I. partial reduction of Black Mass with added carbon in a reducing atmosphere facilitated by gas mixture of CO and CO₂;
II. separating residual carbon from other substances from partially reduced Black Mass using gravity separation;
III. digestion of lithium carbonate and cobalt oxide in a cooled aqueous solution facilitated by CO₂ injection and carbonate-bicarbonate ionic system;
IV. filtering nickel oxide and manganese oxide from leachate solution containing soluble lithium and cobalt species
V. complete reduction of nickel oxide with added carbon in a reducing atmosphere facilitated by gas mixture of CO and CO₂
VI. separating magnetic metallic nickel from non-magnetic tailing using wet magnetic separation;
VII. precipitation of lithium carbonate and cobalt carbonate hydrate from the leachate solution via evaporative crystallization;
VIII. calcination of precipitated crystal mixture to form cobalt oxide and lithium carbonate.

2. A process according to claim 1 wherein the cobalt oxide and lithium carbonate mixture is reduced in a reducing atmosphere facilitated by gas mixture of CO and CO₂ to form metallic cobalt.

3. A process according to claim 2 wherein the products from cobalt reduction are separated using magnetic separation into metallic cobalt and a slurry stream containing lithium carbonate.

4. A process according to claim 3 wherein the abovementioned slurry stream is dried to obtain lithium carbonate crystal.

5. A process according to claim 1 wherein the cobalt oxide and lithium carbonate mixture is washed using cold water to remove lithium carbonate from cobalt oxide.

6. A process according to claim 5 wherein the lithium carbonate precipitates from the abovementioned washing water using evaporative crystallization.

7. A process according to claim 1 wherein the source of carbon comprises of lignite coal, anthracite charcoal, activated carbon or a type of carbon-bearing substance with limited amounts of volatile and low impurity level.

8. A process according to claim 1 wherein the CO/CO₂ volumetric ratio in gas stream added to partial reduction is from 1:2 to 2:1.

9. A process according to claim 1 wherein the CO/CO₂ volumetric ratio in gas stream added to complete reduction is from 1:1 to 4:1.

10. A process according to claim 1 wherein the temperature of partial reduction of Black Mass from spent NCM LIB is 400-600 degrees Celsius.

11. A process according to claim 1 wherein the temperature of complete reduction of nickel oxide from abovementioned partially reduced Black Mass is 650-800 degrees Celsius.

12. A process according to claim 1 wherein the temperature of decomposition of cobalt carbonate hydrate from abovementioned precipitated crystal mixture is 400-700 degrees Celsius.

13. A process according to claim 2 wherein the temperature of complete reduction of cobalt oxide is 600-750 degrees Celsius.

14. A process according to claim 1 wherein reaction time for partial reduction of Black Mass is 1-4 hours.

15. A process according to claim 1 wherein reaction time for complete reduction of nickel oxide is 2-8 hours.

16. A process according to claim 1 wherein reaction time for decomposition of cobalt carbonate hydrate is 1-4 hours.

17. A process according to claim 2 wherein reaction time for complete reduction of cobalt oxide is 2-8 hours.

18. A process according to claim 1 wherein inert gas such as Argon or Nitrogen is applied during heating or cooling.

19. A process according to claim 1 wherein magnetic strengths in wet magnetic separation for a two-pass practice are 100-200 mT and 200-400 mT.

20. A process according to claim 1 wherein magnetic strength in wet magnetic separation for one-pass practice is 100-200 mT.

21. A process according to claim 1 wherein demineralized water added for lithium carbonate (and cobalt oxide as applicable) digestion is cooled to 0-5 degrees Celsius, and temperature of entire digestion process is maintained at 0-5 degrees Celsius.

22. A process according to claim 1 wherein digestion of lithium carbonate and cobalt oxide is carried out with CO₂ gas injection.

23. A process according to claim 1 wherein the time for digestion of lithium carbonate and cobalt oxide is 1-6 hours.

24. A process according to claim 1 wherein the temperature for evaporative crystallization of lithium carbonate is 60-80 degrees Celsius.

25. A process according to claim 1 wherein the holding time for evaporative crystallization of lithium carbonate is 4-12 hours.
